(19) United States
(12) Patent Application Publication
(10) Pub. No.: US 2015/0306622 A1
(43) Pub. Date: Oct. 29, 2015

(54) Soap Dispenser Holder

(71) Applicant: Graeme Edward ASHWORTH, Morley (AU)

(72) Inventors: Graeme Edward ASHWORTH, Morley (AU); Edward Joseph KHOURY, Bateman (AU)

(21) Appl. No.: 14/759,069

(22) PCT Filed: Oct. 18, 2013
(86) PCT No.: PCT/AU2013/001206

§ 371 Date: Jul. 2, 2015

(30) Foreign Application Priority Data
Oct. 19, 2012 (AU) 2012904585

(51) Int. Cl. B05B 15/06; A47K 5/12; F16M 13/02; F16B 47/00; F16B 2/08

(52) U.S. Cl. CPC B05B 15/061; F16B 47/00; F16B 47/006; F16B 2/08; F16M 13/022; A47K 5/1211

(57) ABSTRACT

A soap dispenser holder (10) for supporting a dispensing bottle (11) comprising a body (12) securable to a vertical surface (18). A protruding portion (20) extends outwardly from a first surface (13) of the body (12) having an outer concave surface (22) into which is received an edge of a cap (24) of the dispensing bottle (11). A lip portion (23) is provided along a lower edge of the concave surface (22) to engage with a lower edge of the cap (24). A flexible strap (14) is provided having a first end secured adjacent a first side of the outer concave surface (22) and a second end securable adjacent a second side of the outer concave surface (22) such that the flexible strap (14) is securable around the cap (24) of the dispensing bottle (11).

### FIELD OF THE INVENTION

The present invention relates to a device used for supporting a soap dispenser.

### BACKGROUND TO THE INVENTION

Liquid soap is commonly used in the household as well as many other locations. Such liquid soap is generally provided in a bottle having a pump type dispenser fitted into the opening for dispensing the liquid. These pump type dispenser bottles are generally left standing on a counter top in a suitable location, such as alongside a basin or sink.

Liquid soap dispenser bottles are available which include a means to support the bottle above the counter top, for example from a nearby wall. While these devices are useful for clearing the surface around the sink or basin, they are generally designed as bottles to be retained and refilled as required. The present invention relates to a device for supporting existing liquid soap dispenser bottles of a variety of sizes.

### SUMMARY OF THE INVENTION

According to one aspect of the present invention there is provided a soap dispenser holder for supporting a dispensing bottle comprising:
a body securable to a vertical surface;
a protruding portion extending outwardly from a first surface of the body having an outer concave surface into which is received an edge of a cap of the dispensing bottle;
a lip portion along a lower edge of the concave surface to engage with a lower edge of the cap; and
a flexible strap having a first end secured adjacent a first side of the outer concave surface and a second end securable adjacent a second side of the outer concave surface;
   wherein the flexible strap is securable round the cap of the dispensing bottle.

Preferably, the protruding portion includes an outermost wall portion defining the concave outer surface wherein the outermost wall portion has an arcuate cross section of a constant radius from an upper edge to a lower edge thereof.

Preferably the lip portion comprises an arcuate flange extending transversely to the outer concave surface from a lower edge thereof.

In a preferred embodiment, the lip portion includes a horizontal upper surface provided to engage with the lower edge of the cap such that the dispensing bottle is supported against downward movement relative to the outer concave surface by the lip portion.

Preferably the protruding portion includes a cavity such that the second end of the securing strap is received through an opening into the cavity and secured therein.

In a preferred embodiment, the securing strap is formed of a flexible elastic material having a widened end portion adjacent a first end thereof and a plurality of holes adjacent a second end thereof and wherein a first opening is provided adjacent a first end of the outer concave surface and a second opening is provided adjacent a second end of the outer concave surface such that the widened end of the securing strap is provided to engage with the first opening and the second end of the securing strap is securable within the cavity by engaging one of the holes over a lug provided within the cavity adjacent the second opening.

In a preferred embodiment, a suction cup is provided securable adjacent a second surface of the body to support the body from the vertical surface.

In one embodiment, the body comprises a disc and the suction cup is circular in shape having a diameter larger than that of the disc.

Preferably the suction cup includes a lug thereon provided to engage in an aperture provided adjacent a midpoint of the body.

In a preferred embodiment, the lug includes a distal head portion and a narrowed neck portion and the aperture includes a widened lower portion and a narrowed upper portion such that the lug can be inserted into the lower portion and moved upwardly so that the neck portion engages into the narrowed upper portion.

In one embodiment, the protruding portion extends from the first surface of the body generally between a midpoint thereof and a lower edge thereof and includes an upper surface extending from an upper edge of the concave outer surface to the first surface adjacent the midpoint of the first surface and a lower surface extending generally parallel to the upper surface from the lower edge of the concave outer surface.

The upper and lower surfaces of the protruding portion are preferably oriented generally perpendicular to the vertical surface in use.

Preferably the widened lower portion of the aperture is provided in the upper surface of the protruding portion.

### BRIEF DESCRIPTION OF THE DRAWINGS

The invention will now be described, by way of example, with reference to the following drawings, in which:

FIG. 1a is an upper perspective view of a soap dispenser holder in accordance with the present invention;

FIG. 1b is a front view of the soap dispenser holder of FIG. 1a;

FIG. 2a is a top view of the soap dispenser holder of FIG. 1;

FIG. 2b is a side view of the soap dispenser holder of FIG. 1;

FIG. 3 is an exploded view of the soap dispenser holder of FIG. 1;

FIG. 4a is a front view of the soap dispenser holder of FIG. 1 secured to a vertical surface;

FIG. 4b is a cross sectional view of the soap dispenser holder of FIG. 4a through the line D-D;

FIG. 5 is a cross sectional view of the soap dispenser holder of FIG. 4a through the line C-C;

FIG. 6a is an upper perspective view of the soap dispenser holder secured to a vertical surface holding a dispenser bottle; and

FIG. 6b is an upper perspective view of the soap dispenser holder secured to the vertical surface holding an alternative dispenser bottle.

### DETAILED DESCRIPTION OF PREFERRED EMBODIMENTS

Referring to Figures, there is shown a soap dispenser holder 10 for supporting a dispenser bottle 11. The dispenser bottle 11 comprises generally a vessel 60 having a cap 24 secured to an opening therein. The cap 24 includes a pump head 25 which may be depressed to extract fluid from within the vessel 60.

The soap dispenser holder 10 comprises generally a body 12, a securing strap 14 and a securing device for fixing the body 12 to a vertical surface 18. The securing device in the embodiment shown comprises a suction cup 16. The body 12 is to be located adjacent the vertical surface 18, which may be a tiled or glass wall in a location where the dispenser bottle 11 is to be used.

In the embodiment shown, the body 12 comprises generally a disc having a first surface 13 located in use remote from the vertical surface 18 and a second surface 15 located adjacent the vertical surface 18. The suction cup 16 is circular in shape having a diameter slightly larger than that of the disc and is secured to the body 12 adjacent the second surface 15 thereof.

The securing strap 14 is provided to extend from the first surface 13 of the body 12 to engage with and support the dispensing bottle 11.

The first surface 13 of the body 12 includes a protruding portion 20 extending outwardly therefrom. The protruding portion 20 includes an outermost wall portion 62 defining a concave outer surface 22. The outermost wall portion 62 has an arcuate cross section of a constant radius from an upper edge to a lower edge thereof.

The concave outer surface 22 is provided to engage with a side surface of the cap 24 of the dispensing bottle 11. The concave outer surface 22 is generally of a similar diameter to that of the cap 24 of a standard dispensing bottle 11. The lower edge of the outer concave surface 22 includes a lip portion 23. The lip portion 23 comprises an arcuate flange extending transversely to the outer concave surface 22. That is, the lip portion 23 extends in a generally horizontal plane in use. The lip portion 23 includes an upper surface 27 which is provided to engage with a lower edge of the cap 24 such that the dispensing bottle 11 is supported against downward movement relative to the outer concave surface 22 by the lip portion 23.

The protruding portion 20 extends from the first surface 13 of the body 12 generally between a midpoint thereof and a lower edge thereof. The protruding portion 20 includes an upper surface 28 extending from the upper edge of the concave outer surface 22 to the first surface 13 adjacent the midpoint of the first surface 13 and a lower surface 29 extending generally parallel to the upper surface 28 from the lower edge of the concave outer surface 22. The upper and lower surfaces 28 and 29 of the protruding portion 20 are oriented generally perpendicular to the vertical surface 18 in use. That is, when the body 12 is oriented in a vertical plane secured to the vertical surface 18, the upper and lower surfaces 28 and 29 are oriented generally horizontally.

The protruding portion 20 also includes a first side surface 30 extending between the upper and lower surfaces 28 and 29 on a first side thereof and a second side surface 31 extending between the upper and lower surfaces 28 and 29 on a second opposite side thereof.

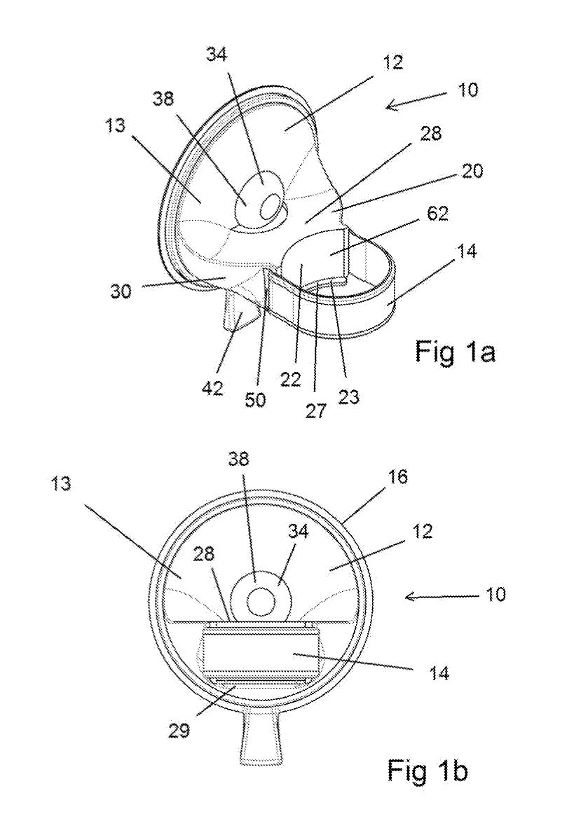

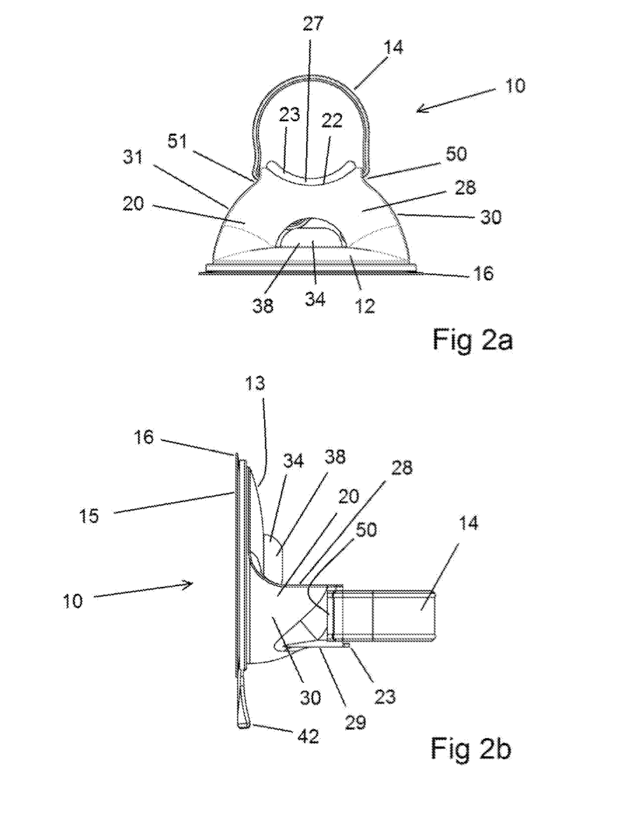

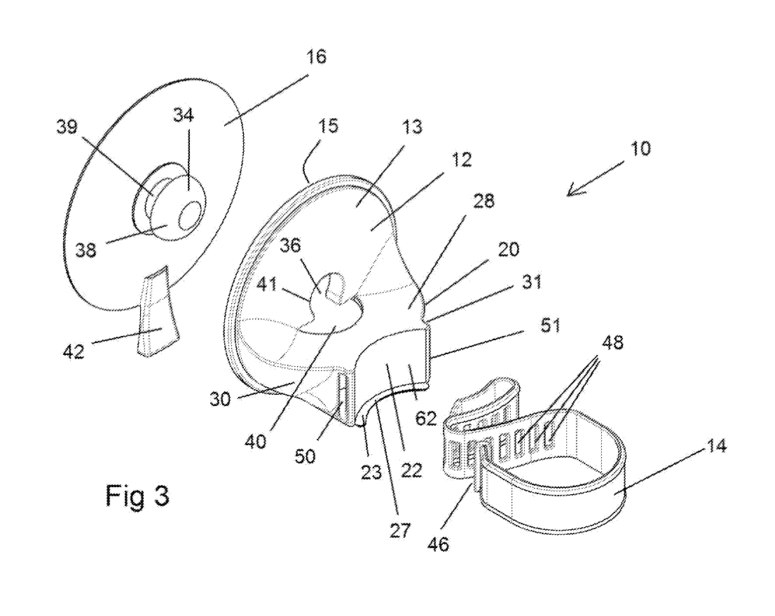

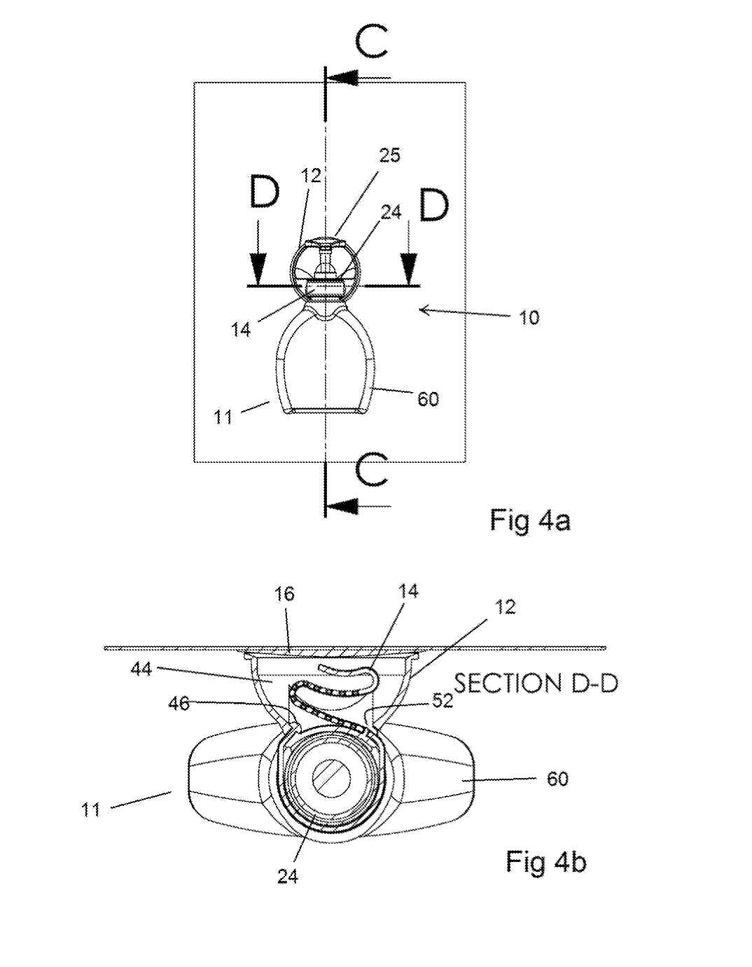

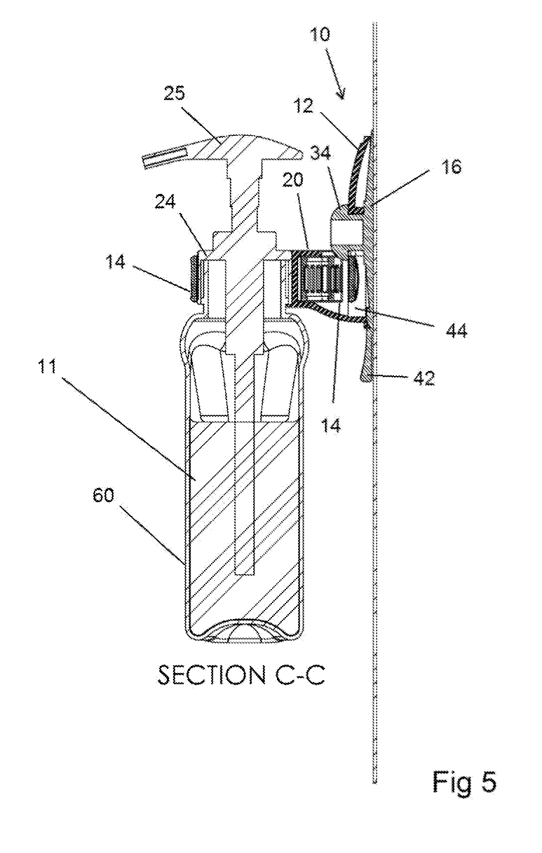

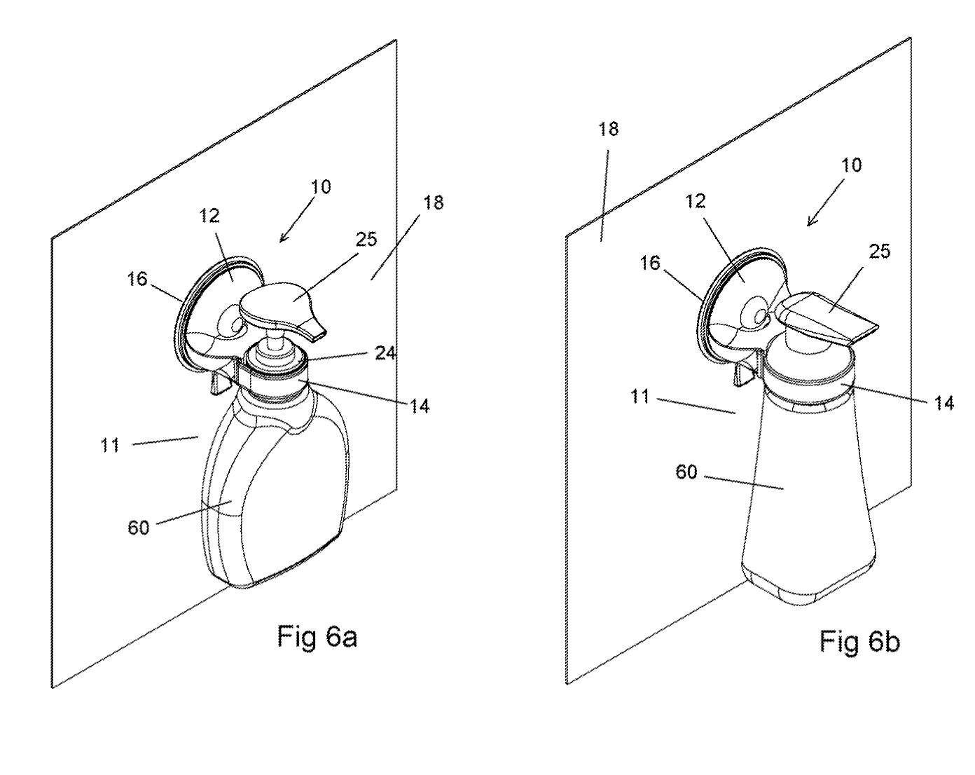

The suction cup 16 includes a lug 34 thereon provided to engage in an aperture 36 provided adjacent the midpoint of the body 12. The lug 34 includes a distal head portion 38 and a narrowed neck portion 39. The aperture 36 includes a widened lower portion 40 and a narrowed upper portion 41 such that the lug 34 can be inserted into the lower portion 40 and moved upwardly so that the neck portion 39 engages into the narrowed upper portion 41. In this position (as can be seen in FIG. 1), the head portion 38 is located in front of the first surface 13 of the body 12 such that the body 12 is supported from the suction cup 16. The widened lower portion 41 in the embodiment shown is provided in the upper surface 28 of the protruding portion 20, as can be seen in FIG. 3.

The suction cup 16 includes also a tab 42 extending outwardly from a side thereof. The tab 42 is provided to enable a side of the suction cup 16 to be lifted away from the vertical surface 18 to disengage the soap dispenser holder 10 from the surface.

The securing strap 14 is formed of flexible elastic material, such as a suitable plastic or rubber based material. The securing strap 14 includes a widened end portion 46 adjacent a first end thereof and a plurality of holes 48 adjacent a second end thereof.

The protruding portion 20 of the body 12 is formed of a thin wall such that a cavity 44 is defined between the protruding portion 20 and the vertical surface 18 in use. The protruding portion 20 includes a first opening 50 provided adjacent a first end of the outer concave surface 33 and a second opening 51 provided adjacent a second end of the outer concave surface 33. The first opening 50 is provided in the first side surface 30 of the protruding portion 20 and the second opening 51 is provided in the second side surface 31 of the protruding portion 20.

The widened end 46 of the securing strap 14 is provided to engage with the first opening 50. The securing strap 14 is inserted from the cavity 44 through the first opening 50 and the widened end 46 engages to retain the first end of the securing strap 14. From this position, the securing strap 14 can be placed around the cap 24 of the dispensing bathe 11 when the cap 24 is placed against the outer concave surface 22. The second end of the securing strap 14 is passed back into the cavity 44 through the second opening 51 and is pulled tight around the cap 24. The second end of the securing strap 14 is then securable within the cavity 44 by engaging one of the holes 48 over a lug 52 provided within the cavity 44 adjacent the second opening 51.

In this way, the securing strap 14 holds the dispensing bottle 11 against the outer concave surface 22. The free second end of securing strap 14 can be neatly stored within the cavity 44 and the body 12 and secured dispensing bottle 11 supported from the suction cup 16 by inserting the lug 34 into the cavity 44 and then moving the body 12 downwardly to engage the lug 34 into the upper narrowed portion 41 of the opening 36.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A soap dispenser holder fbr supporting a dispensing bottle comprising:
a body securable to a vertical surface;
a protruding portion extending outwardly from a first surface of the body having an outer concave surface into which is received an edge of a cap of the dispensing bottle;
a lip portion along a lower edge of the concave surface to engage with a lower edge of the cap; and
a flexible strap having a first end secured adjacent a first side of the outer concave surface and a second end securable adjacent a second side of the outer concave surface;
wherein the flexible strap is securable around the cap of the dispensing bottle.

15. The soap dispenser holder in accordance with claim 14, wherein the protruding portion includes an outermost wall portion defining the concave outer surface wherein the outermost wall portion has an arcuate cross section of a constant radius from an upper edge to a lower edge thereof.

16. The soap dispenser holder in accordance with claim 15, wherein the lip portion comprises an arcuate flange extending transversely to the outer concave surface from a lower edge thereof.

17. The soap dispenser holder in accordance with claim 16, wherein the lip portion includes a horizontal upper surface provided to engage with the lower edge of the cap such that the dispensing bottle is supported against downward movement relative to the outer concave surface by the lip portion.

18. The soap dispenser holder in accordance with claim 17, wherein the protruding portion includes a cavity such that the second end of the securing strap is received through an opening into the cavity and secured therein.

19. The soap dispenser holder in accordance with claim 18, wherein the securing strap is formed of a flexible elastic material having a widened end portion adjacent a first end thereof and a plurality of holes adjacent a second end thereof and wherein a first opening, is provided adjacent a first end of the outer concave surface and a second opening is provided adjacent a second end of the outer concave surface such that the widened end of the securing strap is provided to engage with the first opening and the second end of the securing strap is securable within the cavity by engaging one of the holes over a lug provided within the cavity adjacent the second opening.

20. The soap dispenser holder in accordance with claim 19, wherein a suction cup is provided securable adjacent a second surface of the body to support the body from the vertical surface.

21. The soap dispenser holder in accordance with claim 20, wherein the body comprises a disc and the suction cup is circular in shape having a diameter larger than that of the disc.

22. The soap dispenser holder in accordance with claim 21, wherein the suction cup includes a lug thereon provided to engage in an aperture provided adjacent a midpoint of the body.

23. The soap dispenser holder in accordance with claim 22, wherein the lug includes a distal head portion and a narrowed neck portion and the aperture includes a widened lower portion and a narrowed upper portion such that the lug can be inserted into the lower portion and moved upwardly so that the neck portion engages into the narrowed upper portion.

24. The soap dispenser holder in accordance with claim 23, wherein the protruding portion extends from the first surface of the body generally between a midpoint thereof and a lower edge thereof and includes an upper surface extending from an upper edge of the concave outer surface to the first surface adjacent the midpoint of the first surface and a lower surface extending generally parallel to the upper surface from the lower edge of the concave outer surface.

25. The soap dispenser holder in accordance with claim 24, wherein the upper and lower surfaces of the protruding portion are oriented generally perpendicular to the vertical surface in use.

26. The soap dispenser holder in accordance with claim 25, wherein the widened lower portion of the aperture is provided in the upper surface of the protruding portion.

27. The soap dispenser holder in accordance with claim 14, wherein the protruding portion includes a cavity such that the second end of the securing strap is received through an opening, into the cavity and secured therein.

28. The soap dispenser holder in accordance with claim 14, wherein a suction cup is provided securable adjacent a second surface of the body to support the body from the vertical surface.

29. The soap dispenser holder in accordance with claim 15, wherein the protruding portion includes a cavity such that the second end of the securing strap is received through an opening into the cavity and secured therein.

30. The soap dispenser holder in accordance with claim 15, wherein a suction cup is provided securable adjacent a second surface of the body to support the body from the vertical surface.

31. The soap dispenser holder in accordance with claim 16, wherein the protruding portion includes a cavity such that the second end of the securing strap is received through an opening into the cavity and secured therein.

32. The soap dispenser holder in accordance with claim 16, wherein a suction cup is provided securable adjacent a second surface of the body to support the body from the vertical surface.

33. The soap dispenser holder in accordance with claim 17, wherein the protruding portion includes a cavity such that the second end of the securing strap is received through an opening into the cavity and secured therein.
